(19) United States
(12) Patent Application Publication
(10) Pub. No.: US 2006/0157084 A1
(43) Pub. Date: Jul. 20, 2006

(54) Automatic washing machine detergent dispensing device

(76) Inventors: Ralf Wiedemann, Ludwigshafen (DE); Judith Preuschen, Ludwigshafen (DE); Karl-Heinz Mohrhard, Ludwigshafen (DE)

Correspondence Address: NORRIS, MCLAUGHLIN & MARCUS, 875 THIRD AVE, 18TH FLOOR, NEW YORK, NY, 10022, US

(21) Appl. No.: 10/560,207

(22) PCT Filed: Jun. 3, 2004
(86) PCT No.: PCT/GB04/02354

§ 371 Date: Dec. 9, 2005

(30) Foreign Application Priority Data
Jun. 10, 2003 (GB) 0313304.8

(51) Int. Cl. B08B 9/20; B08B 3/00

(52) U.S. Cl. 134/25.2; 134/56 D

(57) ABSTRACT

An automatic washing machine detergent dispensing device comprises a bar of detergent disposed within a channel. The detergent bar completely fills at least a portion of the channel across the entire bore of the channel. The channel has an inlet aperture which is in communication therewith.

The present invention is related to an automatic washing machine detergent dispensing device, particularly for receiving and holding a detergent composition and/or additive and for dispensing said detergent/additive into an automatic washing machine over a plurality of washing cycles.

In automatic dishwashing machines, the detergent, whether in powder, tablet or gel form, is usually filled manually by the user into the machine, in particular into a detergent holder, before each dishwashing operation.

This filling process is inconvenient, with the problem of exact metering of the detergent and possible spillage thereof, for powder and gel detergents. Even with detergents in tablet form, wherein the problem of accurate dosing is overcome, there is still the necessity of handling the dishwashing detergent every time a dishwashing cycle is started. This is inconvenient because of the usually corrosive nature of dishwasher detergent compositions.

A number of devices are known for holding unit doses of a detergent composition or additive, such as detergent tablets, and for dispensing of such unit doses into a machine.

For example, WO 88/06199 discloses a loader for holding and dispensing a washing additive including a receptacle in which there is a plurality of compartments each for receiving washing additive tablets. The compartments are at least partially defined by partitions forming part of a body, which is movable to bring each tablet adjacent to an opening provided in the receptacle. The tablets then pass through the opening to be dispensed, preferably under force of gravity.

DE 43 44 205 A1 describes a device for dispensing detergent tablets. The dosing device is mounted on the door of a dishwashing machine and loaded with a number of detergent tablets. The dosing device has an ejector for dispensing a single tablet each time the dishwashing machine is used. In a preferred embodiment, the dosing device has a reception shaft for receiving the detergent tablets one after the other, with the ejector being located at the bottom end of the shaft.

WO 01/07703 discloses a device for the metered release of a detergent composition or additive into a dishwashing machine having a number of separate closed chambers for holding the detergent composition or additive and means for opening the chambers, activated by conditions within the machine.

However, each of these devices suffers from several disadvantages.

Although the devices solve some of the problems outlined above, the devices have to be complex in order to ensure that the correct detergent/tablet dose is discharged into the dishwasher cycle at the correct time. This level of complexity is exacerbated by the variation in dishwasher cycle length and temperature present in the many differing automatic dishwasher devices present in the market place. The level of complexity required increases the cost of the devices and reduces the level of benefit provided to the consumer.

Furthermore, space inside an automatic dishwasher is typically at a premium. Normally the external dimensions of the device are limited by what a consumer will tolerate in the kitchen/utility room. At the same time the consumer has high demands in terms of the amount of houseware which can be washed in a dishwasher cycle. Thus space inside the machine is directed towards maximum accommodation of houseware. This means that there is only a very limited amount of space available for a device within the dishwasher. This is not a problem for a small device such as a dishwasher tablet (which dissolves during the wash anyway) or a small/slender device such as a fragrance emanator but is a problem for the devices described above. This problem is compounded as the high level of complexity increases the size of the device.

There is still a need to have a simple device which can release the required amount detergent to achieve good cleaning but which is simple and therefore neither costly nor bulky.

According to a first aspect of the present invention there is provided an automatic washing machine detergent dispensing device comprising a bar of detergent disposed within a channel, wherein the detergent bar completely fills at least a portion of the channel across the entire bore of the channel, the channel having an inlet aperture which is in communication therewith.

The device is preferably for use in an automatic washing machine. Preferred examples of which include automatic dishwasher and automatic laundry machines. Most preferably the device is for use in an automatic dishwasher machine.

The device according to the invention offers much greater ease for the consumer as this device provides a multi-dose detergent apparatus which the consumer can place in an automatic dishwasher machine and run the machine, without further detergent addition, for a plurality of wash cycles. The device does not suffer from the disadvantages associated with multi-dose detergent devices of the prior art as its simplicity enables the device to have a small volume, allowing ease of placement within the dishwashing machine. Also as the device does not rely on any complex construction/complex operating mechanism the device may be produced at low cost.

A further advantage of the simple construction of the device is that the amount of detergent remaining in the device is clear as the detergent content is not obscured by a complex operating mechanism/awkward integration into the dishwasher. Thus the consumer can easily detect when the device is empty and requires replacement (end-of-life-indication).

It has been found that the device is able to provide effective dosing of detergent over a plurality of wash cycles. More particularly the device has been found to be able to release a uniform/equal amount of detergent in each dishwasher cycle for a individual dishwasher using the same washing program in consecutive wash cycles.

Without wishing to be bound by theory it is postulated that the uniform/predictable release property arises due to the arrangement of the detergent bar within the channel. With such an arrangement a portion of the detergent bar contacts the channel and is thus protected by the channel, i.e. is not exposed to the wash liquor. This leaves a second portion of the detergent bar, which extends across the bore of the channel, exposed to the wash liquor. The surface area of this second exposed portion is determined by the bore of the channel.

In use in a washing machine the detergent is dispensed and thus the portion of the detergent exposed to the wash liquor “retreats” along the channel. Most preferably the channel has a uniform bore, in terms of the cross sectional area of the bore, along its length/at least along the portion filled by the detergent bar. This allows the surface area of the exposed portion of the detergent bar to remain constant as the exposed portion of the bar retreats along the channel. Thus any problems of decreasing/altering surface area, such as would be experienced with a simple 3-dimensional block, the surface area of which decreases as the block is dispersed, are overcome.

As washing liquor parameters (amount of liquor, temperature of liquor) are usually similar for each wash cycle especially in the case of an individual dishwashing machine/cycle this aids to ensure that a similar amount of detergent is dispensed per wash cycle. Indeed in this regard it has been observed that in the higher intensity washing cycles, those which employ a larger amount of water and/or water at a higher temperature, the amount of detergent dispensed per wash cycle is increased. It is proposed that this higher level of release is connected with greater solubility of detergent in the more stringent washing conditions. This higher release of detergent is entirely suited to the requirements of a consumer when a higher intensity washing cycle has been selected.

Generally the channel is a tube. Most preferably the tube is cylindrical, although any cross-sectional shape is possible (e.g. regular/irregular polygon such as a triangle, square, rectangle, pentagon, hexagon). The tube may include a smaller tube disposed along a portion of its length. Such a tube may provide additional structural integrity for the detergent bar. Where a second tube is present it is preferred that the second tube has a uniform cross section along its length/the length of the detergent bar, thus the surface area of the detergent bar exposed to the wash liquor is constant as the detergent bar retreats along the channel.

The channel is completely filled along a portion of its length across the entire cross-section thereof by the detergent bar. Thus a portion of the detergent bar is in contact with the interior of the channel and is thus protected by the channel, i.e. not exposed to wash liquor. A second portion of the detergent bar, which extends across the bore of the channel, is exposed to the wash liquor.

Most preferably the exposed portion of the detergent bar comprises a planar surface. Generally the planar surface is perpendicular to the periphery of the channel.

Most preferably the channel only has one open end which communicates with the inlet aperture to allow wash liquor to contact the detergent bar. Preferably the open end of the channel comprises the inlet aperture. As an example the channel may comprise a form similar to a drinking glass.

In an alternative arrangement the channel may have a plurality of (such as two) open ends each of which being in communication with an inlet aperture to allow wash liquor to contact the detergent bar. As an example the channel may thus comprise a tube with both ends open to wash liquor and the detergent bar disposed at a central portion of the tube.

Clearly other designs which include a plurality of channels, comprising an admixture of a single open-ended channels and/or channels having a plurality of open ends, are hereby contemplated. In such a device each channel component may have a bespoke bore which is preferably constant at least along the portion thereof occupied by the detergent bar.

Most preferably the channel has a secondary aperture. The secondary aperture may be required, dependent on the positioning and/or orientation of the device to provides a drainage function to allow excess wash liquor to run away form the detergent bar between wash cycles (or even in between wash segments). The secondary aperture may thus aid the prevention of excessive erosion/deterioration of the detergent bar caused by residual wash liquor between washes. Additionally the secondary aperture may prevent the development of detrimental water turbulence within the channel, which could case premature/ineffective detergent dispense. The drainage function of the secondary aperture may provide extra stability to the device in the washing machine, when in use.

The secondary aperture may comprise a slit in a side of the channel.

The device may comprise a plurality of secondary apertures. These may be arranged in a variety of different formations. Preferred formations are where the apertures are disposed in a line along at least a portion of the length of the channel. The line may include spacing between the secondary apertures. Where present, it is preferred that the spacing is such that the secondary apertures at least partially overlap one another. This provides a constant loss of wash liquor in each position, which avoids the creation of instability in the device when in use. The line may include irregularities and thus differ from a straight line/regular curve. Where a plurality of secondary apertures are present it is preferred that the secondary apertures comprise circular holes in the channel periphery.

It will be appreciated that the secondary apertures, as well as providing a drainage/stability function, may also allow wash liquor to come into contact with the detergent bar. This could cause dissolution of the detergent bar in a region around the secondary aperture such that the surface area of the detergent bar exposed to the wash liquor varies with increasing use. Thus it is most preferred that means are employed to counter this action.

One example of countering means includes a barrier arranged around the periphery of the channel. The barrier thus prevents wash liquor from contacting the exterior of the channel. Generally the barrier is distanced from the periphery of the channel such that the secondary apertures may still allow the excess water to drain away into said space. Normally the space has a further drainage aperture. The barrier preferably comprises a sleeve arranged around the exterior of the channel. The sleeve may comprise a rigid material, such as the material which comprises the channel. Alternatively the sleeve may comprise a flexible material such as a textile or film. Further the sleeve may comprise a filter element (such as a sieve) to prevent clogging of the secondary apertures (e.g., with food residues).

A further example is where the diameter of the secondary aperture is dimensioned such that it allows maximum drainage yet only permits a minimum amount of incoming wash liquor.

A still further consideration is that preferably the diameter of the second aperture is larger than the holes of the dishwasher sieve. No food residues can then clog the secondary aperture.

To achieve these aims the secondary aperture diameter is typically less than 5 mm, more preferably less than 4 mm and most preferably less than 3 mm. The secondary aperture diameter is typically more than 0.5 mm, more preferably more than 1 mm and most preferably more than 1.5 mm. With such a small secondary aperture diameter it has been found that the detergent bar exerts an influence on the flow of water through the secondary aperture. Namely it has been found that the detergent bar lowers the surface tension of the wash liquor in the region of the secondary apertures on the inside of the channel. This has the effect that the flow of water through the secondary apertures towards the detergent bar is improved.

Preferably the angle of the secondary aperture relative to the surface of the channel is typically less than 90°, more preferably less than 85° and most preferably less than 80°. The angle is typically more than 45°, more preferably more than 50° and most preferably more than 60°.

In a preferred embodiment of the invention the dispensing device has a means to control the amount of wash liquor which contacts the detergent bar.

Preferably the means comprises a collecting funnel which collects wash liquor and directs it towards the inlet aperture into the channel. Most preferably the collecting funnel and inlet aperture are arranged so that the only way in which wash liquor can enter the channel is via the collecting funnel. This may be achieved by having the dispensing portion of the collecting funnel abutting against the internal periphery of the inlet aperture. Alternatively this may be achieved by the provision of a diaphragm which extends between the internal periphery of the inlet channel and the dispensing portion of the collecting funnel.

Most preferably the collecting funnel has a drainage opening in its collecting portion. This drainage opening ensures that the level of wash liquor in the collecting portion of the funnel does not exceed a certain predetermined level. If it is assumed that the collecting funnel is filled up to the drainage aperture for the duration of the wash and/or rinse cycles then the amount of wash liquor discharged from the collecting funnel into the channel will be largely constant.

The channel is most preferably formed of a water-resistant/water-insoluble material. Most preferably the channel comprises a water insoluble material. Preferred materials for the channel include glass, ceramic, metal and plastics materials such as polyolefins, e.g. polypropylene or polyethylene. Plastics materials are most preferred due to their resilience and low cost (material and manufacturing costs).

The detergent bar most preferably comprises an automatic dishwasher detergent. As such the detergent bar formulation typically contains one or more detergent components such as builders, co-builders, surfactants, bleaches, bleach activators/catalysts, enzymes, polymers (as thickeners/chelants), salts, dyes, pigments, fragrances, water and organic solvents.

Preferred examples of automatic dishwasher detergents include conventional detergents, and the “2-in-1” and “3-in-1” variants. Most preferably the detergent bar comprises a solid so that the rigours of the movement of the washing machine liquor will not cause the entire detergent bar to be dispensed/discharged in the first washing cycle. In the context of the present invention the term solid can be taken to include solidified gels as well as conventional solid materials (such as compressed particulate materials and solidified molten/cross-linked materials)

The detergent bar contains sufficient detergent for a plurality of dishwasher wash cycles. Preferably the detergent bar contains sufficient detergent for between 3 to 20 dishwasher wash cycles, more preferably from 5 to 12 dishwasher wash cycles.

Optionally the detergent bar comprises a detergent additive. Preferred detergent additives include rinse aids, bleaches, anti-spotting compositions (e.g., such as that sold under the trade name of Jet-Dry) and also glass corrosion prevention compositions such as those containing zinc (in the form of a glass, glass granulate, or other soluble form).

Optionally the detergent bar comprises a component which is insoluble at an elevated temperature. As the rinse cycle of a dishwashing machine has an elevated operating temperature and usually has the highest operating temperature of the entire washing cycle, this limits the amount of detergent which would otherwise be dispensed into the rinse cycle, where it would have a detrimental effect on the rinsing process.

Preferably the component is soluble at up to about 50° C. This temperature dependent behaviour is called LCST-behaviour (Lower Critical Solution Temperature). Preferred components include alkylated and hydroxy-alkylated cellulose derivatives and copolymers of isopropylacrylates. A preferred example is Klucel, a hydroxypropylcellulose (available from Hercules Corp). This polymer dissolves 100% in water until 38° C. and starts to precipitate above this temperature.

To ensure that the detergent amount released is constant in different wash cycles the device may compromise an additional temperature sensitive means which at least partially closes the inlet aperture at higher washing temperature (such as 70° C.).

Where the device comprises a plurality of channels, each channel may contain a different detergent/detergent additive. This is especially useful where one of the detergents/detergent additives is detrimental to another detergent. Thus for example one channel may contain a bleach (bleaches are recognised to be detrimental to most other detergent components).

According to a second aspect of the present invention there is provided the use of an automatic washing machine detergent dispensing device in an automatic washing machine process, wherein the device comprises a bar of detergent disposed within a channel, the detergent bar completely filling at least a portion of the channel across the entire bore of the channel, the channel having an inlet aperture which is in communication therewith.

Most preferably the device is used at a convenient portion of the interior of an automatic dishwashing machine. Preferred portions include. Generally the device is easily accessible and clearly visible. The front part of the upper rack is preferred.

When the dispensing device comprises a form which is similar to a drinking glass it is most preferably that the device is used in the automatic washing machine in an upright position (i.e. with the opening facing upwards). In this orientation it has been found that the problems of adherence between the detergent bar and the channel are overcome.

According to a third aspect of the present invention there is provided an automatic washing machine process, comprising a detergent dispensing device, wherein the device comprises a bar of detergent disposed within a channel, the detergent bar completely filling at least a portion of the channel across the entire bore of the channel, the channel having an inlet aperture which is in communication therewith.

It will be appreciated that the features of the first aspect of the invention apply mutatis mutandis to the second and third aspects of the present invention.

The invention is now further described with reference to the following non-limiting Examples.

### EXAMPLES

In the Examples the following detergent composition (as shown in Table 1) was used as a detergent formulation.

TABLE 1

| Component | % |
|---|---|
| Sodium Tripolyphosphate | 34.0 |
| Sodium Carbonate | 20.0 |
| Dye | 0.02 |
| Sodium Hydroxide (50% solution) | 13.0 |
| Sodium Silicate | 24.0 |
| Sodium Sulphate | 1.2 |
| Sodium Polyacrylate | 1.0 |
| Nonylphenoxytetraethoxyethanol | 0.6 |
| water | To 100% |

The detergent formulation was made into a bar.

Test Method

In the Examples the detergent bar was added to a test dishwasher (Bosch SGS 5602) which was run for a plurality of cycles.

Dosage: Described in each example.

Water Hardness in the machine: 18GH, central softening through ion exchangers, internal ion exchangers not in operation.

Cleaning Program: 55° C. (both the cleaning and the rinse cycle were operationed at 55° C.).

Water consumption per cycle: 23.5 litres.

The weight loss of the detergent bar was determined gravimetrically.

### Comparative Example 1

In this Comparative Example a simple detergent bar, without a device in accordance with the present invention, was added to the machine. The mass of the bar was 18.1 g.

The results of the tests are shown in Table 2 (Mass Loss).

TABLE 2

| | Detergent Released |
|---|---|
| Wash Cycle | per wash cycle (g) |
| 1 | 9.81 |
| 2 | 7.6 |
| 3 | 0.68 |

The amount of detergent released per wash cycle decreases with an increasing number of wash cycles following an inverse exponential relationship. The decreasing dispense amount is caused by the surface area of the detergent block decreasing as the detergent is dispensed.

### Example 1

In this Example the detergent bar was added to the machine, wherein the detergent bar was disposed in a dispensing device in accordance with the present invention. The mass of the bar was 177.9 g.

The results of the tests are shown in Table 3 (Mass Loss).

TABLE 3

| | Detergent Released |
|---|---|
| Wash Cycle | per wash cycle (g) |
| 1 | 2.75 |
| 2 | 3.57 |
| 3 | 3.87 |
| 4 | 2.36 |
| 5 | 3.13 |
| 6 | 3.69 |
| 7 | 3.99 |
| 8 | 3.35 |
| 9 | 2.3 |
| 10 | 3.47 |

The amount of detergent released per wash cycle remains constant over a number of wash cycles. The constant dispense amount is due to the surface area of the detergent block remaining constant as the detergent is dispensed.

Thus the device in accordance with the invention has been shown to be able to release a constant and effective amount of detergent per wash cycle. This is in contrast to the results obtained in the Comparative Example.

The invention is now further described with reference to the following Figures in which:

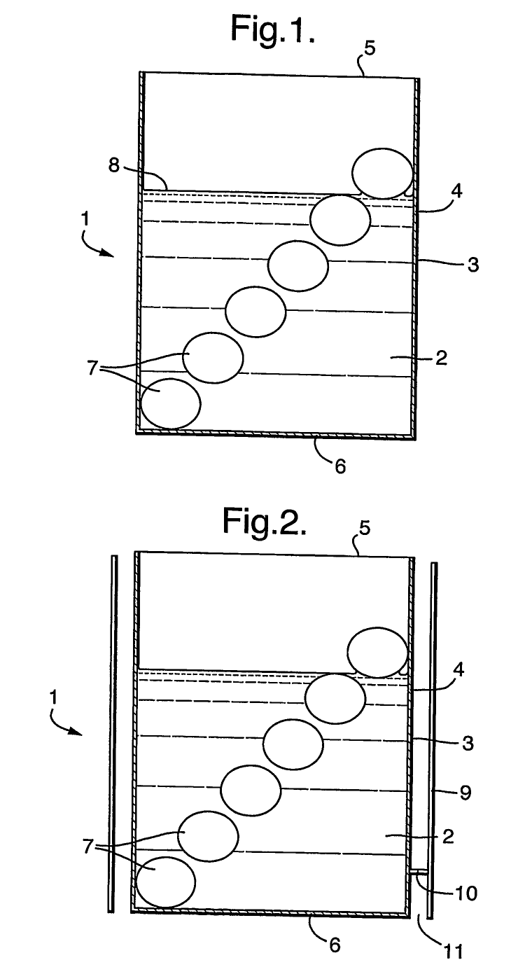

FIG. 1 is a side view of a first embodiment of a detergent dispensing device in accordance with the present invention;

FIG. 2 shows the embodiment of FIG. 1 with an additional wash liquor barrier; and

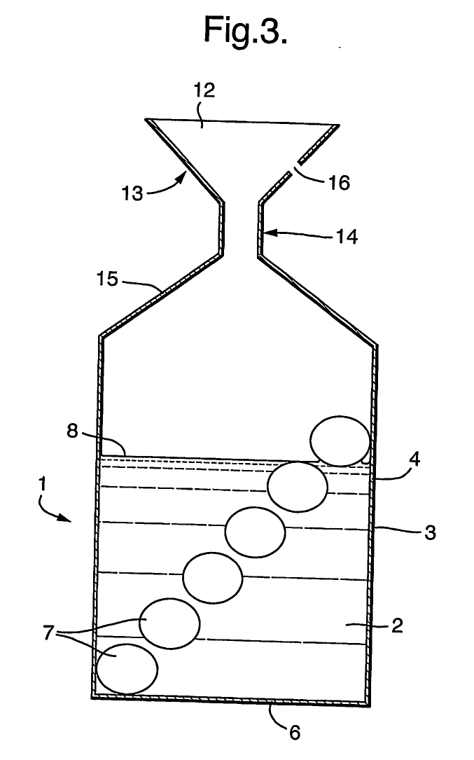

FIG. 3 is a side view of a second embodiment of a detergent dispensing device in accordance with the present invention, having a means to control the amount of wash liquor which contacts the detergent bar.

FIG. 1 shows a detergent dispensing device 1. The device 1 comprises a detergent bar 2 which is disposed within a body 3.

The body 3 comprises a channel 4. The channel 4 has a circular cross-section and is thus in the form of a cylindrical tube. The channel 4 has an open end 5, which comprises an inlet aperture, and a closed end 6. The closed end 6 acts as a base.

In the periphery of the channel 4 there are a plurality of circular drainage apertures 7. The drainage apertures are arranged in a curved line extending from the closed end 6 towards the open end 5.

The channel 4 preferably comprises a water-resilient/water-insoluble material such as a plastics material (e.g. polypropylene or poylethylene).

Due to the arrangement of the detergent bar 2 the detergent bar comprises a surface 8 which is exposed, with the remainder of the detergent bar 2 being protected by contact with the interior of the channel 4.

In use the device 1 is disposed in an automatic dishwashing machine (not shown). During operation of the dishwashing machine the wash liquor comes into contact with the device 1. The exposed surface 8 of the detergent bar 2 comes into contact with the wash liquor and becomes dispersed into the wash liquor. When the detergent bar 2 is dispensed the exposed surface 8 retreats along the channel 4 towards the closed end 5.

As the surface area of the exposed surface 8 is determined by the bore of the channel 4 a pre-determined amount of detergent bar 2 is exposed to the wash liquor. Also as the bore of the channel 4 is constant along its length the exposed surface 8 of the detergent bar 2 is constant as the detergent bar 2 retreats. This helps to ensure that a constant amount of detergent is released per wash cycle.

Depending on the orientation of the device 1 the wash liquor which has become loaded with detergent from the detergent bar 2 may flow away from the device 1 through one or more of the drainage apertures 7 or through the open end 5. In the preferred orientation of the device (with the open end 5 uppermost) the loaded wash liquor flows from the device via the drainage apertures 7. The presence of the drainage apertures 7 aids the stability of the dispensing device 1. More specifically the drainage apertures 7 aid the inhibition of turbulent water formations (not shown) on the exposed surface 8. These turbulent water formations could cause instability of the device 1 and/or inefficient dispense of the detergent bar 2.

In FIG. 2 the detergent dispensing device 1 shown in FIG. 1 has a wash liquor barrier 9. The wash liquor barrier 9 comprises a sleeve around the channel 4. The barrier 9 is connected to the channel 4 via one or more joining rods 10 (for clarity only one rod 10 is shown).

The presence of the barrier 9 reduces the amount of wash liquor which enters the drainage apertures 7 and causes erosion of the detergent bar 2 in the region of the drainage apertures 7. However, the presence of the barrier 9 does not prevent wash liquor from contacting the exposed surface 8 of the detergent bar 2, nor the flow of detergent loaded wash liquor away from the device 1. The loaded liquor can flow away from the device 1 via a passage 11 between the interior of the barrier 9 and the exterior of the channel 4. Thus effective discharge of the detergent bar 2 can still be achieved.

In FIG. 3 the detergent dispensing device shown in FIG. 1 has a means to control the amount of wash liquor which contacts the detergent bar. Said means comprises a funnel 12 having a collecting portion 13 and a directing portion 14.

The device 1 has a diaphragm 15 which extends from a portion of the open end 5 to the directing portion 14. Thus the diaphragm 15 effectively encloses the exposed portion 8 of the detergent bar 2 from the wash liquor. Now for wash liquor to come into contact with the exposed surface 8 of the detergent bar 2, the wash liquor has to pass through the funnel 12.

In the preferred orientation of the device 1 wash liquor collects in the collecting portion 13 of the funnel 12 and passes into contact with the exposed surface 8 of the detergent bar 2 via the directing portion 14. Most preferably the collecting portion 13 has an opening 16 along a portion of its length. The presence of opening 16 in the collecting portion 13 means that wash liquor may only collect in the collecting portion 13 up to the height of the opening 16, before being directed into contact with the exposed surface 8. Excess wash liquor is discharged away from the device 2 down the side of the channel 4.

By exercising control over the amount of wash liquor directed into contact with the detergent bar 2 or more specifically by limiting the amount of water which is allowed to contact the detergent bar 2, the amount of detergent dispensed in wash cycle can be limited.

It will be appreciated that the invention is not intended to be overly limited by reference to the FIGS. 1 to 3.

1. An automatic washing machine detergent dispensing device comprising a detergent bar comprising a detergent composition, a detergent additive, or a detergent composition which includes a detergent additive, said detergent bar disposed within a channel, wherein the detergent bar completely fills at least a portion of the channel across the entire bore of the channel, the channel having an inlet aperture which is in communication therewith.

2. A device according to claim 1, wherein the channel has a uniform bore, along its length or at least along the portion filled by the detergent bar.

3. A device according to claim 1, wherein the channel is a tube.

4. A device according to claim 4, wherein the tube is cylindrical.

5. A device according to claim 1, wherein the channel has one open end which communicates with the inlet aperture.

6. A device according to claim 5, wherein the channel comprises a form similar to a drinking glass.

7. A device according to claim 1 wherein the channel has a plurality of open ends each of which being in communication with an inlet aperture.

8. A device according to claim 5, wherein the channel comprises a tube both ends of which are open.

9. A device according to claim 5, wherein the open end of the channel comprises the inlet aperture.

10. A device according to claim 1, wherein the channel has a secondary aperture.

11. A device according to claim 10, wherein the secondary aperture comprises a slit in the side of the channel.

12. A device according to claim 10, wherein the secondary aperture may comprise a plurality of separate apertures.

13. A device according to claim 1, wherein a barrier is arranged around the periphery of the channel.

14. A device according to claim 13, wherein the barrier comprises a sleeve arranged around the exterior of the channel.

15. A device according to claim 10, wherein the diameter of the secondary aperture is larger than the holes of the dishwasher sieve.

16. A device according to claim 10, wherein the diameter of the secondary aperture is less than 5 mm.

17. A device according to claim 1, wherein the device comprises a means to control the amount of wash liquor which contacts the detergent bar.

18. A device according to claim 17 claim 17, wherein the means comprises a collecting funnel.

19. A device according to claim 18, wherein the collecting funnel has a drainage opening in its collecting portion.

20. A device according to claim 1, wherein the channel comprises a water-resistant or water insoluble material.

21. The use of an automatic washing machine detergent dispensing device in an automatic washing machine in an automatic washing machine process, wherein the device comprises a bar of detergent disposed within a channel, the detergent bar completely filling at least a portion of the channel across the entire bore of the channel, the channel having an aperture which is in communication therewith.

22. An automatic washing machine process, comprising the step of providing to an automatic washing machine a detergent dispensing device, wherein the device comprises a bar of detergent disposed within a channel, the detergent bar completely filling at least a portion of the channel across the entire bore of the channel, the channel having an aperture which is in communication therewith.
